(19) United States
(12) Patent Application Publication
(10) Pub. No.: US 2003/0106508 A1
(43) Pub. Date: Jun. 12, 2003

(54) Two-cycle engine with forward scavenging air positioning and single-flow carburetor

(75) Inventor: Heiko Rosskamp, Adelberg (DE)

Correspondence Address: ROBERT W. BECKER & ASSOCIATES, Suite B, 707 Highway 66 East, Tijeras, NM, 87059, US

(73) Assignee: Andreas Stihl AG & Co., Waiblingen (DE)

(21) Appl. No.: 10/305,616

(22) Filed: Nov. 26, 2002

(30) Foreign Application Priority Data
Dec. 10, 2001 (DE) 101 60 539.0

(51) Int. Cl. F02B 33/04

(52) U.S. Cl. 123/73 PP

(57) ABSTRACT

A two-cycle engine having forward scavenging is provided, as used in manually-guided implements. The mixture is drawn into the crankcase via a butterfly valve carburettor and is conveyed into a combustion chamber via transfer channels formed in the cylinder. An air duct is connected via a controllable connection with a transfer channel in order during a load state of the engine to supply essentially fuel-free air to the transfer channel. In order during idling and partial load to convey a fuel quantity adapted to the drawn-in air, yet during full throttle to achieve a separated supply of air and mixture, a dividing wall that extends in the direction of flow of air is provided in the intake duct of the carburettor. In the pivot region of the butterfly valve, a connecting aperture is provided in the dividing wall and is closed in full throttle by a completely open butterfly valve. In contrast, during idling and partial load the connecting aperture is open so that a uniform pressure can form in the intake duct in conformity with the drawn-in air.

### BACKGROUND OF THE INVENTION

The present invention relates to a two-cycle engine, especially as a drive engine in a portable, manually-guided tool or implement such as a power chain saw, a brush cutter, a trimmer, a cut-off machine, etc.

A two-cycle engine of this type is known from DE 199,00 445 A1. A combustion chamber formed in the cylinder is connected to the crankcase via transfer passages, the mixture required for combustion being conveyed to the crankcase. In order to ensure that as little uncombusted fuel as possible is lost through the exhaust or outlet during the scavenging of the combustion chamber, the transfer passages close to the exhaust are connected to an air duct and fuel-free air is drawn in through the transfer passages during the intake stroke. The air is then held at the front of the transfer passages and enters first the next time the mixture transfers into the combustion chamber. The mixture flowing out of the crankcase follows some time later and the scavenging losses flowing out of the exhaust during the scavenging of the combustion chamber come largely from the forward positioned scavenging air.

In practice, a number of problems occur during the metering of the fuel required to operate the internal combustion engine by a carburetor. For example, at idle it is necessary to guarantee that the air duct is fully closed in order to prevent the idle mixture becoming too lean in an uncontrolled manner in the combustion chamber as a result of the air flowing into it. During acceleration, too, the opening of the air duct renders the mixture too lean as a result of which the speed of the internal combustion engine increases only reluctantly to the desired level.

On the other hand, it is important to guarantee that the air duct remains as free as possible from fuel at full throttle in order that the significant reduction in exhaust gas emissions which the forward positioned scavenging air is designed to achieve can be obtained.

The invention is based on the object of designing a two-cycle engine of the aforementioned type in such a manner that it is possible to reliably prevent the mixture in the combustion chamber from becoming too lean at idle and part throttle while retaining the advantageous effects of the supply of fuel-free air with which to scavenge the combustion chamber at full throttle.

### BRIEF DESCRIPTION OF THE DRAWINGS

This object, and other objects and advantages of the present invention, will appear more clearly from the following specification in conjunction with the accompanying schematic drawings, in which:

FIG. 1 is a schematic view of a two-cycle engine with port-controlled forward scavenging air positioning and a single-flow carburetor.

FIG. 2 is a schematic section along the line marked 11-11 in FIG. 1.

FIG. 3 is a schematic view of a section of a membrane-controlled system with forward scavenging air positioning as illustrated in FIG. 2.

FIG. 4 is a schematic sectional view through a carburetor with a throttle valve and a choke valve.

FIG. 5 is a schematic view of the front face of a carburetor with an eccentrically positioned butterfly valve shaft.

### SUMMARY OF THE INVENTION

A dividing wall in the intake duct of the carburetor divides the venturi along its longitudinal center line into an intake duct section and an air duct. Here the dividing wall is essentially provided along the entire length of the intake duct from one front face of the carburetor body to its other front face in such a manner that even fuel precipitating due to return pulsation upstream of the butterfly or throttle valve is unable to simply pass into the air duct. A connecting aperture is formed in the dividing wall in the pivot region of the throttle valve. At full throttle the throttle valve closes the connecting aperture in the dividing wall in such a manner that the dividing wall, which extends as far as the upstream front face, opposes any transfer of fuel upstream of the throttle valve. The dividing wall preferably extends as far as the base of an air filter fitted upstream of the carburetor, expediently into the air filter housing and in particular as far as the filter element itself. The extension of the dividing wall upstream of the throttle valve into the filter housing achieves a functional division of air duct and mixture duct on the intake side.

The design disclosed in the invention ensures that the pressure prevailing in the venturi at idle and part throttle corresponds to the joint pressure in the air duct and the mixture duct. The volume of fuel conveyed into the venturi in accordance with this joint underpressure is thus proportional to the volume of air conveyed, irrespective of whether it is conveyed to the combustion chamber via the mixture duct or the air duct. This prevents the mixture from becoming too lean at both idle and part throttle.

Similarly, if a choke valve is provided this arrangement guarantees that the underpressure prevailing due to the adjustment of the choke is the same throughout the entire system in such a manner that under choke conditions, too, a volume of fuel adapted to the volume of air drawn in is conveyed and mixed with the air.

In order to achieve a dry, i.e. largely fuel-free, air duct at full throttle, the aperture edge of the connecting aperture and the edge of the valve overlap. Here the overlapping aperture edge can be designed as a seat for the edge of the valve and the aperture edge can also have a seal.

### DESCRIPTION OF PREFERRED EMBODIMENTS

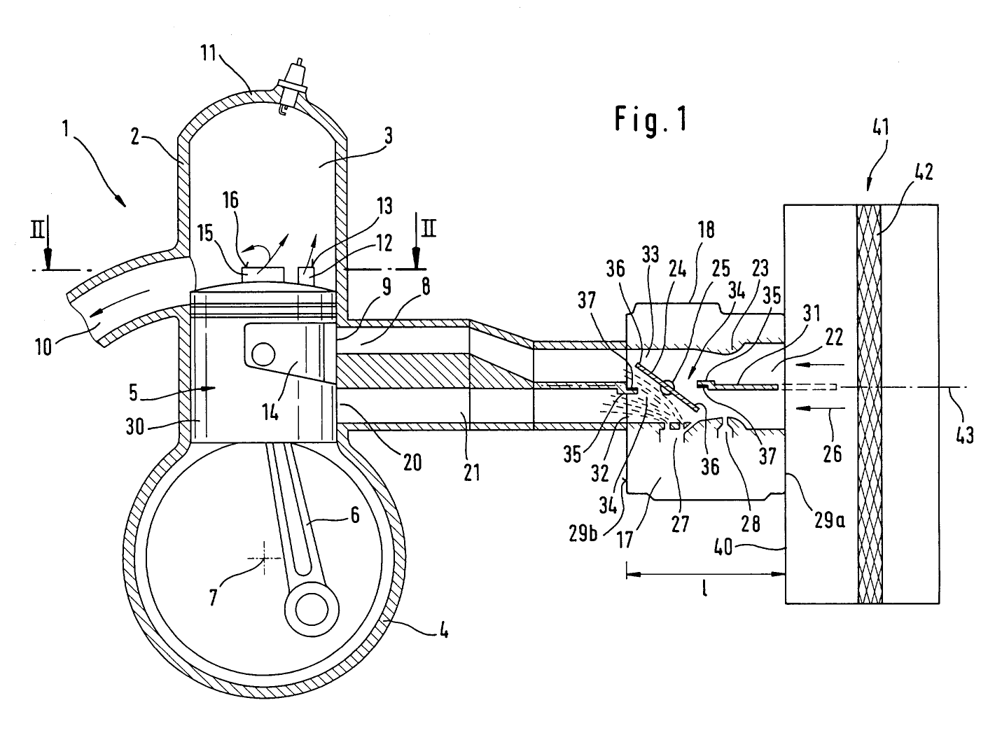

The two-cycle engine illustrated schematically in FIG. 1 is used as a small-volume drive engine preferably in manually operated, portable tools such as, for example, chain saws, brush cutters, parting-off grinders, etc. The displacement of an internal combustion engine of this type lies within a range of 18 cm³ and 500 cm³.

The two-cycle engine has a cylinder in which is provided a combustion chamber which is delimited by a reciprocating piston. Via a connecting rod, the piston drives a crankshaft which is mounted in a crankcase in such a manner that it can rotate.

An inlet, which in the illustrated embodiment is controlled by the piston skirt, opens into the crankcase. In the embodiment shown, the inlet is therefore opened and closed dependent upon the stroke position of the piston. It can be useful to provide a membrane or diaphragm control system instead of the piston port control system illustrated. The inlet then opens into the crankcase outside the piston stroke area, it being necessary to position a membrane valve which opens in the direction of the crankcase in the inlet. The opening of the inlet is then controlled by underpressure.

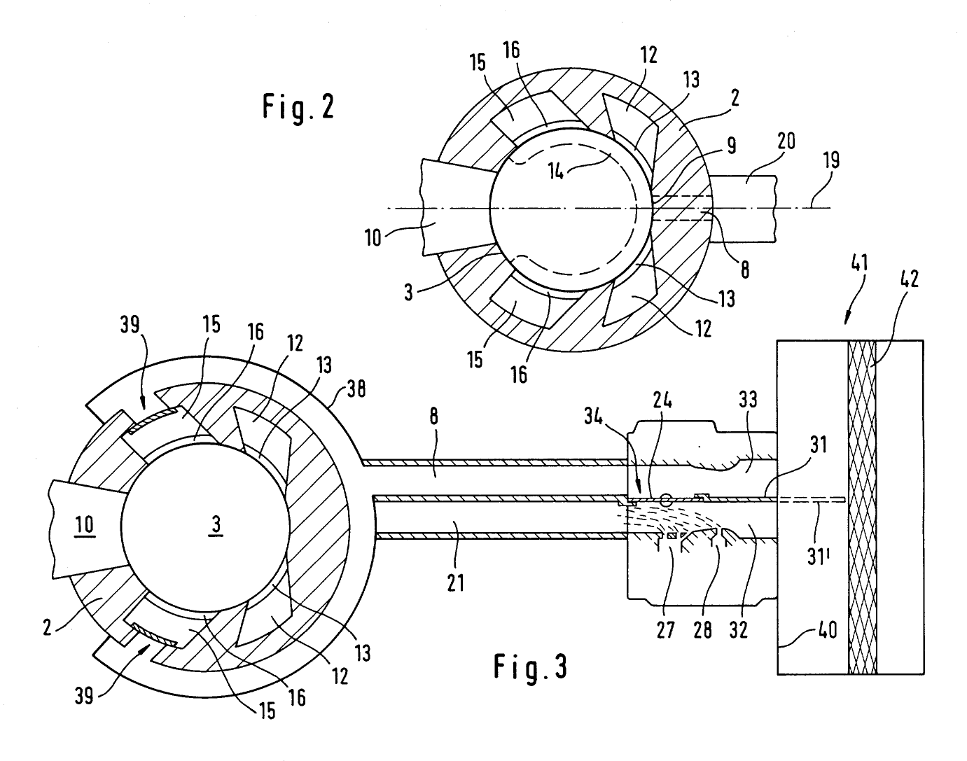

The crankcase is connected to the combustion chamber via transfer passages, these transfer passages—see. FIG. 2—being designed as straight or handle-shaped passages in the side wall of the cylinder. In the version illustrated, two transfer passages and two transfer passages are provided, one of each on either side of a plane of symmetry. The transfer passages are located close to an outlet or exhaust which conveys exhaust gases out of the combustion chamber and are also referred to as exhaust transfer passages. The transfer passages are positioned some distance from the exhaust and are referred to as exhaust-distant transfer passages. As illustrated in the section shown in FIG. 2, the plane of symmetry divides the cylinder into symmetrical halves and runs roughly centrally through the exhaust and the inlet.

The end of each transfer passage facing the cylinder head opens into the combustion chamber via a transfer window or port. The transfer ports are controlled by the piston as it reciprocates, the transfer ports being open in a lower piston position close to bottom dead center (BDC) illustrated in FIG. 1 and being closed in an upper piston position between BDC and top dead center (TDC). The ends of the transfer passages facing the crankcase are open in both the lower and the upper piston positions.

Furthermore, the transfer passages can also be connected to an air duct which opens into an air port in the wall of the cylinder. A connecting port is formed in the piston skirt at the level of the air port and, as illustrated in FIG. 2, extends from the air port opposite the exhaust in both directions around the circumference of the piston covering a circumferential angle of some 120° such that in the corresponding piston stroke position the transfer ports communicate with the connecting port, the connecting port being designed such that it also connects with the air port of the air duct in this piston stroke position. Thus, when the piston rises towards TDC, a connection is made between the air duct and the transfer ports and due to the underpressure prevailing in the crankcase at the time, medium is drawn in from the air duct through the transfer passages.

The air duct and an inlet duct leading to the inlet are connected separately to a mixture formation device which is a carburetor in the embodiment shown. The carburetor is expediently a diaphragm carburetor of the type predominantly used in drive engines in portable, manually operated tools. In the carburetor body is a joint intake duct with a venturi. Also positioned in the intake duct is a throttle or butterfly valve which is mounted on a throttle shaft in the carburetor body in such a manner that it is able to rotate. The common intake duct is divided by means of a partition or dividing wall which extends along the longitudinal center line in the direction of the air flow. The fuel feeders, in the embodiment illustrated idle jets and a main fuel jet, are located on one side of the dividing wall which extends essentially from one front face to the other front face of the carburetor body along the entire length of the intake duct. Here the part of the duct which contains the fuel feeders forms an intake duct section which is connected to the inlet duct The other part of the duct forms an air duct which is connected to the air duct of the air port. In the area of rotation of the throttle valve is a connecting aperture in the dividing wall which forms a connection between the intake duct section and the air duct. This connection creates identical pressure conditions on both sides of the dividing wall when the connecting aperture is open. When the connecting aperture is open, the diaphragm carburetor therefore conveys a volume of fuel which is always proportional to the volume of air drawn in via the jets.

In the part throttle position illustrated in FIG. 1, the throttle valve is located half open transverse to the longitudinal center line in the intake duct, the axis of rotation of the throttle valve being located exactly in the plane of the dividing wall. In this throttle valve position, the connecting aperture is partially open and the fuel drawn in through the fuel jets therefore enters both the intake duct section and the air duct via the open connecting aperture. At idle and/or part throttle, both the air duct and the inlet duct therefore convey a fuel/air mixture, it being possible, due to the arrangement of the jets in the intake duct section, for the fuel/air mixture conveyed in the inlet duct to be richer than that conveyed in the air duct into which fuel is only allowed to enter via the partially opened connecting aperture.

Downstream of the carburetor the intake duct section is connected to the inlet via the inlet duct, and the air duct is connected to the air port via the connecting or air duct. Downstream of the carburetor the air ducts therefore run separately from the mixture ducts.

When the internal combustion engine is in operation, as the piston rises towards TDC the transfer ports and the exhaust are closed. The rising piston opens the inlet and at the same time or a few crank angle degrees later connects the air port to the transfer ports via the connecting port. Thus at the same time as the air duct is connected to the transfer passages or slightly earlier, the inlet to the crankcase is opened, allowing the mixture to flow into the crankcase. When the air port of the connecting port is connected to the transfer windows, a fuel-lean mixture or largely fuel-free air is drawn in and flows down through the transfer ports to the crankcase. The transfer passages thus fill with lean mixture or with largely fuel-free air, the transfer passages close to the exhaust preferably being filled with air.

Following ignition, the piston descends to BDC again, the flow connection between the transfer passages and the air duct being interrupted and the inlet being closed. Since the piston is descending, the mixture drawn into the crankcase is compressed and, as the piston-controlled transfer ports are opened, flows into the combustion chamber, filling it with fresh mixture for the next compression stroke. Here the fuel-lean or fuel-free air is positioned forward of the rich mixture in the crankcase and scavenging losses flowing out through the open exhaust are therefore largely formed by the fuel-lean mixture and the fuel-free air.

At full throttle, the throttle valve is fully open as illustrated in the example of a diaphragm or membrane-controlled forward scavenging air positioning system shown in FIG. 3. When the throttle valve is fully open it lies roughly parallel to the longitudinal center line such that the air duct and the intake duct section are completely separate from each other since the throttle valve preferably seals the connecting aperture. In order to achieve this, the connecting aperture is designed with a slightly smaller throughput section than that of the valve itself. The aperture edge of the connecting aperture and the edge of the throttle valve overlap one another, thereby achieving a sealed fit. Here the aperture edge is expediently designed as a seat for the edge of the valve, the aperture edge expediently bearing a seal. The seal is preferably a rubber seal which may be provided in the form of a gasket or a tied-in seal. This guarantees that the air duct is dry, i.e. free of fuel, at full throttle and thus that scavenging losses which occur during the scavenging of the combustion chamber comprise exclusively of fuel-free air.

In order to guarantee that the air duct remains free of fuel at full throttle, the dividing wall is designed to extend upstream of the carburetor as far as the base of an air filter. If the dividing wall (FIG. 3) is taken into the air filter housing, preferably extended into the area of the filter element, it is possible to prevent fuel from precipitating in the air filter as a result of air pulsation in the intake train from transferring to the air duct.

While in the embodiment illustrated in FIGS. 1 and 2 the connection between the air ducts and the transfer passages are controlled by piston ports, FIG. 3 shows a connection between the air duct and at least the transfer passages close to the exhaust port via a distributor duct and a non-return valve which is designed as a membrane valve in the embodiment. The distributor duct can be designed as an external duct, a hose connection or a duct integrated into the cylinder. As the piston rises, underpressure is created in the crankcase and also in the transfer passages due to the fact that these transfer passages are open to the crankcase. Due to the pressure difference thus created at the membrane valve, the membrane valve opens and fuel-lean mixture/fuel-free air is drawn into the transfer passage close to the exhaust via the membrane valve. As the piston descends, the overpressure which builds up in the crankcase closes the membrane valve. It can also be useful to connect the transfer passages to the air duct via a non-return valve such as a membrane valve, e.g. via a controlled connection to the distributor duct.

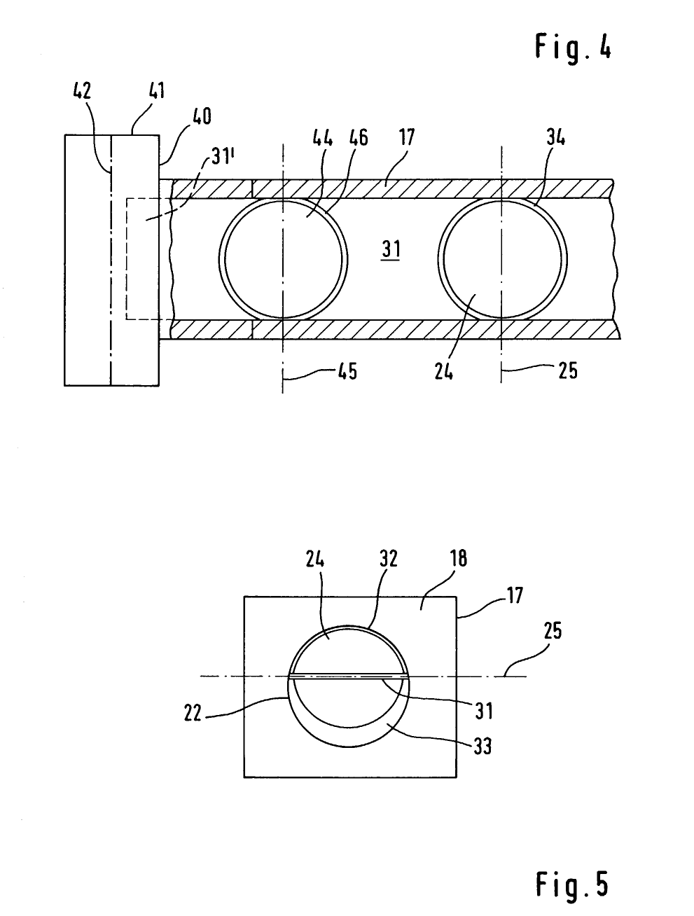

In the embodiment illustrated in FIG. 4, a choke valve is provided upstream of the throttle valve and is mounted on a choke shaft in the carburetor or the carburetor body in such a manner that it can rotate. The choke shaft is located in the plane of the dividing wall. The choke valve is associated with a further connecting aperture in the dividing wall, whereby when the choke valve is in the open position illustrated in FIG. 4 the further connecting aperture is largely closed by the choke valve. Here it is possible to provide sealing measures such as those which have already been described in relation to the throttle valve. This design guarantees that when the choke and the partially opened throttle valve are actuated, the higher intake underpressure produced takes effect in both the air duct and the mixture duct, the pressure conditions in the venturi are therefore identical and a volume of fuel proportional to the volume of air drawn in is metered.

It can be expedient to position the dividing wall in the carburetor body eccentrically in relation to the intake duct thereby giving the air duct and the mixture duct different cross sectional areas. In this case, the throttle shaft and a choke shaft continue to be located approximately in the plane of the dividing wall, but slightly offset relative to the center of the intake duct as shown in FIG. 5. The ratio A/L between the cross sectional area of the intake duct section and the cross sectional area of the air duct lies roughly within a range of 0.5 to 1.9 and preferably within a range of 0.54 to 1.86. This means that the cross sectional area of the air duct can be between 65% and 35% of the total cross sectional area of the intake duct.

The specification incorporates by reference the disclosure of German priority document 101 60 539.0 filed 10 Dec. 2001.

The present invention is, of course, in no way restricted to the specific disclosure of the specification and drawings, but also encompasses any modifications within the scope of the appended claims.

I claim:

1. A two-cycle engine having a cylinder in which is formed a combustion chamber that is delimited by a reciprocating piston which, via a connecting rod, drives a crank shaft that is rotatably mounted in a crank case, wherein an inlet opens into said crankcase, wherein said inlet communicates with an intake duct section of a carburetor via which a fuel/air mixture is to be drawn into said crankcase, wherein a cross-sectional area of said intake duct section is variable via a butterfly valve that during idling of said engine is disposed approximately transverse to a longitudinal central axis of said intake duct section and during full throttle is disposed approximately parallel to said longitudinal central axis, wherein at least one transfer channel is formed in said cylinder and connects said crankcase with said combustion chamber, wherein at an end facing a cylinder head of said cylinder, said at least one transfer channel opens into said combustion chamber via a transfer port that is controlled by said piston and that is open in a lower position of said piston and is closed in an upper position of said piston, wherein an end of said at least one transfer channel that faces said crankcase is open in both said upper and lower positions of said piston, wherein an air duct is provided that via a controllable connection is in communication with said at least one transfer channelin a vicinity of said end of the latter that faces said cylinder head in order, during a load state of said engine, to supply essentially fuel-free air to said at least one transfer channel, and wherein an outlet is provided on said cylinder for conveying exhaust gas away from said combustion chamber, said engine further comprising:
a dividing wall that extends in a direction of flow of air through said carburetor and divides an intake duct of said carburetor such that one duct portion, which is provided with fuel supply means, forms said intake duct section, and another duct portion forms said air duct, wherein said dividing wall extends essentially over an entire length of said intake duct from one end face of a housing of said carburetor to another end face thereof, wherein in a pivot region of said butterfly valve said dividing wall is provided with a connecting aperture that in a full throttle state of said engine is essentially closed by a completely open butterfly valve such that in said full throttle state said air duct and said intake duct section re separated from one another

2. A two-cycle engine according to claim 1, wherein an air filter is disposed upstream of said carburetor, and wherein said dividing wall extends at least to a base of said air filter.

3. A two-cycle engine according to claim 2, wherein said dividing wall extends into a housing of said air filter.

4. A two-cycle engine according to claim 3, wherein said dividing wall extends to a region of a filter element of said air filter.

5. A two-cycle engine according to claim 1, wherein a choke valve is disposed upstream of said butterfly valve, and wherein in the region of said choke valve there is provided in said dividing wall a second connecting aperture that in an open position of said choke valve is essentially completely closed thereby.

6. A two-cycle engine according to claim 5, wherein each respective connecting aperture has a slightly smaller passage cross section than does a surface of a respective one of said valves.

7. A two-cycle engine according to claim 6, wherein an opening edge of a respective connecting aperture overlaps with an edge of the corresponding valve.

8. A two-cycle engine according to claim 7, wherein the overlap opening edge is formed as a sealing seat for said valve edge.

9. A two-cycle engine according to claim 8, wherein said overlapped opening edge is provided with a seal.

10. A two-cycle engine according to claim 9, wherein said seal is a rubber seal.

11. A two-cycle engine according to claim 1, wherein dividing wall divides said intake duct such that a ratio of a cross-sectional area of said intake duct section to a cross-sectional area of said air duct is approximately the range of 0.5 to 1.9.

12. A two-cycle engine according to claim 11, wherein said ratio is in a range of approximately 0.54 to 1.86.

13. A two-cycle engine according to claim 5, wherein a shaft 25,45 of a respective one of said valves is mounted in said housing of said carburetor such that it is eccentric relative to a cross-section of said intake duct.

14. A two-cycle engine according to claim 1, wherein said air duct is connected to said cylinder head end of said at least one transfer channel 15 via a check valve.

15. A two-cycle engine according to claim 14, wherein said check valve is a reed valve.

16. A two-cycle engine according to claim 1, wherein said air duct is connectable with said transfer port of said at least one transfer channel, via a connecting port provided in said piston, as a function of a stroke position of said piston.

17. A two-cycle engine according to claim 1, wherein said mixture inlet is opened at approximately the same time as a connection of said air duct with said at least one transfer channel.

18. A two-cycle engine according to claim 1, wherein said mixture inlet is opened slightly earlier than a connection of said air duct with said at least one transfer channel.
